(19) United States
(12) Patent Application Publication
(10) Pub. No.: US 2010/0218739 A1
(43) Pub. Date: Sep. 2, 2010

(54) METHOD FOR OPERATING AN IGNITION DEVICE FOR AN INTERNAL COMBUSTION ENGINE

(76) Inventors: Werner Herden, Gerlingen (DE); Manfred Vogel, Ditzingen (DE); Heiko Ridderbusch, Schwieberdingen (DE)

Correspondence Address: KENYON & KENYON LLP, ONE BROADWAY, NEW YORK, NY, 10004, US

(21) Appl. No.: 12/304,087

(22) PCT Filed: Jun. 19, 2007
(86) PCT No.: PCT/EP07/56080

§ 371 Date: Apr. 13, 2010

(30) Foreign Application Priority Data
Jul. 4, 2006 (DE) 10 2006 030 722.4

(51) Int. Cl. F02P 23/04; H01S 3/11

(52) U.S. Cl. 123/143 B; 372/10

(57) ABSTRACT

A method is for operating an ignition device for an internal combustion engine, particularly of a motor vehicle, having a laser device which has a laser-active solid having a passive Q-switch and which generates a laser pulse for eradiating into a combustion chamber, and having a pumping light source which provides a pumping light for the laser-active solid of the laser device. A point of ignition, at which the laser pulse is generated, is regulated to a specifiable setpoint value by setting a radiation intensity of the pumping light and/or a pumping duration and/or a pumping starting time and/or a wavelength of the pumping light.

### FIELD OF THE INVENTION

The present invention relates to a method for operating an ignition device for an internal combustion engine, particularly of a motor vehicle, having a laser device which has a laser-active solid having a passive Q-switch and generates a laser pulse for eradiating into a combustion chamber, and having a pumping light source which provides a pumping light for the laser-active solid of the laser device.

The present invention also relates to a control unit for such an ignition device, as well as a computer program for a control unit.

### BACKGROUND INFORMATION

A method for operating an ignition device using a laser is described in DE 199 11 737.

Conventional operating methods for ignition devices of the type mentioned at the outset have the disadvantage that different interference effects, such as temperature changes and manufacturing tolerances in the properties of the components used have a negative effect on the exact maintaining of a desired point of ignition, and with that, they impair the combustion process, particularly with regard to having pollutant emissions that are as low as possible and with regard to the process having a high efficiency.

### SUMMARY

Example embodiments of the present invention provide a method, a control unit and a computer program of the type mentioned at the outset to the extent that, even under the influence of disturbance variables or manufacturing tolerances, the exact maintaining of a desired point of ignition is possible.

According to example embodiments of the present invention, in an operating method of the type mentioned at the outset, a point of ignition, at which the laser pulse is generated, is regulated to a setpoint value, by setting a radiation intensity of the pumping light and/or a pumping duration and/or a pumping starting point and/or a wavelength of the pumping light.

Because of the regulation of the point of ignition, it is advantageously possible to reduce the jitter in time during the generation of laser pulses to values which do not impair an orderly operation, and particularly one that is low in emissions, of the internal combustion engine. When using the regulating method, it is possible, for instance, to limit the jitter in time of laser pulses to values of less than about 10 μs, so that even at high rotational speeds of the internal combustion engine, such as 6,000 rpm, an interference-free operation is ensured.

Additional features, possible uses and advantages of example embodiments of the present invention are described in more detail below in the following description. All of the features described or illustrated constitute the subject matter hereof either alone or in any combination, regardless of the manner they are combined, and regardless of their representation in the description or their illustration in the drawings.

### BRIEF DESCRIPTION OF THE DRAWINGS

FIG. 1 is a schematic representation of an internal combustion engine having an ignition device for use with the method according to example embodiments of the present invention,

FIG. 2 illustrates an example embodiment of the ignition device of FIG. 1, in detail,

FIG. 3 illustrates the curve over time of a firing control of the ignition device of FIG. 1, and

FIG. 4 is a simplified flow chart of a method according to example embodiments of the present invention.

### DETAILED DESCRIPTION

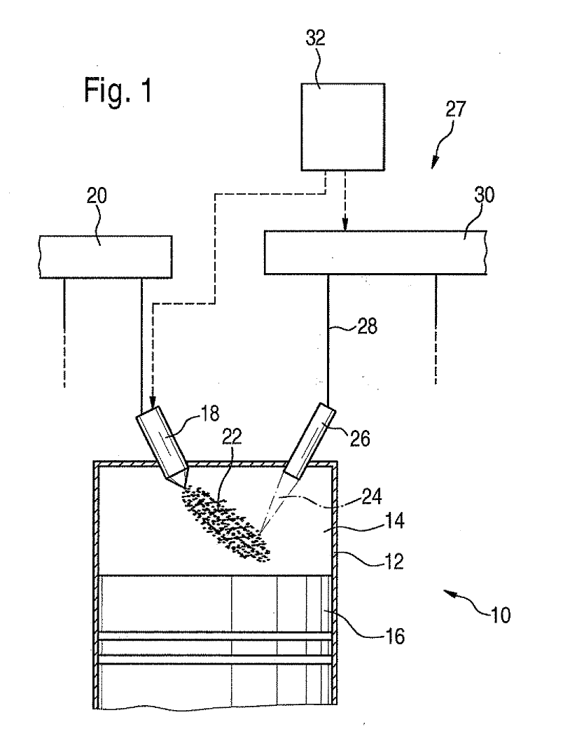

In FIG. 1, an internal combustion engine in its entirety bears reference numeral 10. It is used for driving a motor vehicle that is not shown. Internal combustion engine 10 includes a plurality of cylinders, of which only one, having a combustion chamber 12, is shown in FIG. 1. A combustion chamber 14 of cylinder 12 is bordered by a piston 16. Fuel reaches combustion chamber 14 directly through an injector 18, which is connected to a fuel pressure reservoir 20 that is also designated as a rail, or rather, common rail.

Fuel 22 injected into combustion chamber 14 is ignited using a laser pulse 24, which is eradiated into combustion chamber 14 by an ignition device 27 that includes a laser device 26. For this purpose, laser device 26 is fed, via a light guide device 28, with a pumping light that is provided by a pumping light source 30. Pumping light source 30 is controlled by a control and regulating device 32, which also activates injector 18.

Pumping light source 30 may be a semiconductor laser diode, for instance, which, as a function of a control current, emits an appropriate pumping light via light guide device 28 to laser device 26. Although semiconductor laser diodes, and other pumping light sources that take up little space, are preferred for use in the motor vehicle field, for the purpose of operating ignition device 27 according to example embodiments of the present invention, every type of pumping light source is usable, in principle.

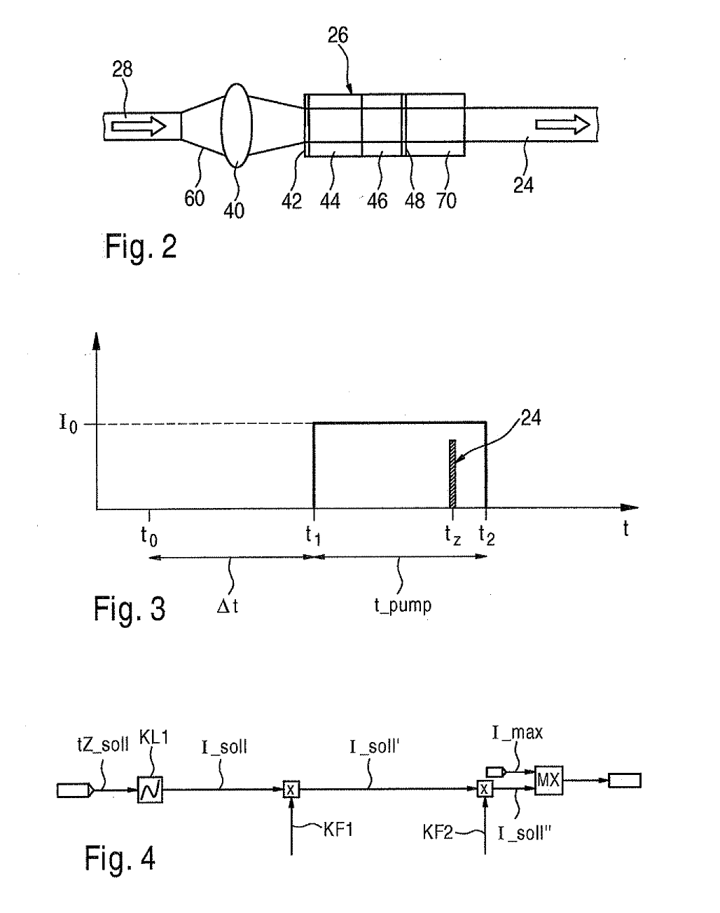

FIG. 2 shows schematically a detailed view of laser device 26 from FIG. 1.

As may be seen in FIG. 2, laser device 26 has a laser-active solid 44 which has optically postconnected to it passive Q-switching 46 also designated as a Q-switch. Laser-active solid 44, together with passive Q-switch 46, as well as coupling mirror 42 situated to the left of laser-active solid 44 in FIG. 2, and output mirror 48 form a laser oscillator, whose oscillating behavior depends on passive Q-switch 46, and that being the case, is at least indirectly controllable in a conventional manner.

In the configuration of laser device 26 illustrated in FIG. 2, pumping light 60 is guided through light guide device 28 that has been described with reference to FIG. 1 from pumping light source 30, also described before, to a coupling optical system symbolized presently by a biconvex lens 40, which bundles pumping light 60 to coupling mirror 42. Since coupling mirror 42 is transparent to wavelengths of pumping light 60, pumping light 60 penetrates into laser-active solid 44 and therein leads to an inversion of distribution that is conventional.

While passive Q-switch 46 is in its idle state, in that it manifests a comparatively low transmission coefficient, laser operation is avoided in laser-active solid 44, or rather, in solid 44, 46 that is bordered by coupling mirror 42 and output mirror 48. However, with increasing pumping duration, the radiation density in laser-oscillator 42, 44, 46, 48 increases, so that passive Q-switch 46 fades, that is, takes on a greater transmission coefficient, and the laser operation is able to begin.

In this manner, a laser pulse 24 is created that is also designated as a giant pulse, which has a relatively high peak power. Laser pulse 24 is coupled into combustion chamber 14 (FIG. 1) of internal combustion engine 10, if necessary, using an additional light guide device, or directly through a combustion chamber window of laser device 26 that is not shown, so that fuel 22 present there is ignited.

If necessary, an optical intensifier 70, for the optical intensification of laser pulse 24, may be assigned to laser-oscillator 42, 44, 46, 48, as shown in FIG. 2. Optical intensifier 70 is not required, however, for use of the method according to example embodiments of the present invention, that is described below.

Based on different interference effects such as temperature fluctuations, ageing effects and manufacturing tolerances in the material properties of laser-active solid 44, etc., since, in spite of invariable fire control, a jitter in time, that is, a fluctuation in time of the appearance of laser pulses 24 is able to come about, the point of ignition at which laser pulse 24 is actually generated is regulated to a specifiable setpoint value, according to example embodiments of the present invention.

On this matter, FIG. 3 gives an overview on the firing control of ignition device 27 according to example embodiments of the present invention. Starting from a starting point to, the first step is waiting for a specifiable waiting time Δt, until finally, beginning at pumping starting point t1, pumping light source 30 of ignition device 27 is activated, and with that, it emits a pumping light 60 having a radiation intensity shown in FIG. 3 as reference value I0 to laser-active solid 44 (FIG. 2). Pumping light source 30 remains activated during entire pumping duration t_pump, which, according to FIG. 3, extends to time t2, that is, t_pump=t2−t1.

Within pumping duration t_pump, on account of the irradiation of laser-active solid 44 with pumping light 60, as described before, an inversion of distribution is built up in it which, after the fading of passive Q-switch 46, finally leads to a laser operation, so that, at an actual point of ignition tZ, the laser pulse also designated by reference numeral 24 is emitted.

The actual occurrence of laser pulse 24 as well as corresponding point of ignition tZ are established, according to example embodiments of the present invention, by measuring means that are known per se and are not described in greater detail here, and are supplied to control device 32 for carrying out the regulating method according to example embodiments of the present invention. Since the actual point of ignition tZ is able to fluctuate, principally based on the interference effects described, pumping duration t_pump is advantageously selected such that it is greater than a specifiable time difference between the expected point of ignition and pumping starting time t1. This time difference is therefore designated also as safety time, and it is supposed to ensure that even when there is a delayed generation of laser pulse 24, the pumping light supply will not be interrupted prematurely.

With reference to the flow chart of FIG. 4, a variant of the regulating method is described in greater detail below.

As input variable for the method according to example embodiments of the present invention, there is a setpoint value tZ_setpoint, which has been ascertained, for example, by control device 32 of internal combustion engine 10 as a function of other operating parameters, and which states when laser pulse 24 is to be eradiated into combustion chamber 14.

Setpoint value tZ_setpoint is supplied to a first characteristics curve KL1, which forms from this, for instance, a setpoint value I_setpoint for the radiation intensity emitted by pumping light source 30. Setpoint value I_setpoint is subsequently transformed to a corrected setpoint value I_setpoint′, by multiplication with a first correction factor KF1. After that, corrected setpoint value I_setpoint′ is transformed into a corrected setpoint value I_setpoint′, by a further multiplication by a second correction factor KF2.

First correction factor KF1 states a functional interrelationship between a temperature of internal combustion engine 10 and radiation intensity I_setpoint of pumping light source 30 that is actually to be set. In the process, according to example embodiments of the present invention, it is taken into account that laser device 26 has nearly the same temperature as internal combustion engine 10 itself, based on its spatial vicinity to internal combustion engine 10, in the direct environment of combustion chamber 14. Therefore, a temperature change in internal combustion engine 10 also effects a temperature change in laser device 26, and in components 44, 46 included in it.

Temperature changes in laser-active solid 44 also have an effect, for instance, on the generation of laser pulse 24 and the efficiency in the utilization of pumping light 60 that is irradiated into laser-active solid 44, and are accordingly taken into account by the power of correction factor KF1, in order always to ensure the setting of the required radiation intensity I_setpoint for pumping light 60, even at different temperatures of internal combustion engine 10 or of laser-active solid 44. Accordingly, corrected value I_setpoint′ represents a setpoint value for the radiation intensity of pumping light 60 that is cleaned up for the temperature of internal combustion engine 10.

Analogously to taking into account, as described above, the temperature of internal combustion engine 10, if a laser diode is used as pumping light source 30, one can also take into account the interrelationship between the temperature of the laser diode and the radiation intensity emitted by the laser diode and the emitted pumping wavelength of pumping light 60, which presently is indicated by correction factor KF2.

Both correction factors KF1, KF2 may be obtained as a function of the respective temperature and a corresponding characteristics curve, ascertained by measurements, for instance, in a conventional manner. The corresponding characteristics curves for ascertaining correction factors KF1, KF2, as well as characteristics curve KL1 may be stored, for instance, in a preferably nonvolatile memory of control unit 32 (FIG. 1).

Corrected setpoint value I_setpoint″ for the radiation intensity, that was obtained in the manner described above, is subsequently compared in a limiter MX to a maximally admissible value for radiation intensity I_max, and, if necessary, it is limited to the latter. Corrected setpoint value I_setpoint′ is subsequently able to be recalculated into a corresponding control current for the laser diode of pumping light source 30, which may also be done via a characteristics curve (not shown).

The subsequent firing control of laser device 26 according to example embodiments of the present invention accordingly takes place by using radiation intensity I_setpoint′, ascertained as described above, for pumping light 60.

Radiation intensity I0 given in FIG. 3 may have, for example, the value I_setpoint′ calculated above. In the case of such a firing control, a subsequent laser pulse 24 comes about at point of ignition tZ, which in turn is recorded by the measuring means already described. Actual point of ignition tZ is recorded for ascertaining a system deviation, and if the system deviation exceeds a specifiable threshold value, a corresponding adjustment according to example embodiments of the present invention takes place of those controlled variables which influence point of ignition tZ.

Instead of setpoint value tZ_setpoint, the system deviation may be used directly as input variable in the flow chart as in FIG. 4, as a function of which, for instance, the radiation intensity of pumping light 60 is able to be adjusted, etc.

In the case of a laser pulse 24 that actually occurs too late, using the method illustrated in FIG. 4, for example, the radiation intensity of pumping light 60 may be increased in such a way that a subsequent laser pulse appears earlier, that is, the system deviation of the regulating method according to example embodiments of the present invention decreases.

Besides using a radiation intensity of pumping light 60 or a corresponding control current of a laser diode developed as a pumping light source 30, it is further possible to set pumping duration t_pump or pumping starting point t1, as well as a wavelength of pumping light 60, in order to influence the actual position in time of laser pulse 24.

The change in the wavelength of pumping light 60 may be made, for instance, using an active tempering of pumping light source 30 that is arranged as a laser diode.

In the case of influencing point of ignition tZ by a modification of pumping duration t_pump, a limitation of pumping duration t_pump to a maximally admissible pumping duration may advantageously be used in order to avoid thermal overloading of pumping light source 30.

In the method according to example embodiments of the present invention, it is particularly advantageously provided that the regulation of the point of ignition of laser pulse 24 takes place as a function of the rotational speed of internal combustion engine 10. Because of this, it is very advantageously possible to carry out especially precise regulation in particularly time-critical operating ranges, which correspond to comparatively high rotational speeds of internal combustion engine 10, for example, whereas, in other operating ranges having lower rotational speeds of internal combustion engine 10, a less accurate regulation of the point of ignition of laser pulse 24 needs to take place. Depending on the operating point of internal combustion engine 10 and the requirements on the maximum jitter in time of laser pulse 24, different control variables may also be modified in order to adjust the point of ignition.

The operating method for ignition device 27, according to example embodiments of the present invention, may be implemented in the form of a computer program, for instance, that is stored in an electronic memory of control unit 32, and that runs on control unit 32, or rather, on a computer (not shown) that is provided in the unit.

It is possible, quite generally, to influence the temporal position of laser pulse 24 simultaneously by a plurality of the influence variables named above. For example, pumping duration t_pump and radiation intensity IO of pumping light 60 may be modified at the same time, etc.

Slight corrections of the temporal position of laser pulse 24 are particularly able to be implemented by themselves, i.e. by a shifting of pumping starting time t1, whereas, for instance, the total omission of a laser pulse 24 is able to be corrected by a change in the influence variables controlling the laser operation, such as in radiation intensity IO as well as pumping duration t_pump or the wavelength of pumping light 60.

Because of the regulating method according to example embodiments of the present invention, described above, for the point of ignition of laser pulse 24, besides temperature fluctuations, other interference effects, such as different doping of laser-active solid 44 as well as different pumping volumes, may be compensated for, for example, as a function of a different pumping jet formation in the coupling region of pumping light 60 into laser-active solid 44, etc. In the same manner, different initial transmission values of passive Q-switch 46 and its influence on the temporal position of laser pulse 24 are able to be compensated for by the method described herein.

In the same manner, different reflection coefficients of coupling mirror 42 and output mirror 48 for pumping light 60 and laser pulse 24 may also be compensated for.

The principle described herein may also advantageously be used in stationary motors.

1-10. (canceled)

11. A method for operating an ignition device for an internal combustion engine having a laser device that includes a laser-active solid having a passive Q-switch, comprising:
generating a laser pulse for eradiating into a combustion chamber;
providing a pumping light, by a pumping light source, for the laser-active solid of the laser device;
regulating a point of ignition, at which the laser pulse is generated, to a specifiable setpoint value by setting at least one of (a) a radiation intensity of the pumping light, (b) a pumping duration of the pumping light, (c) a pumping starting time of the pumping light, and (d) a wavelength of the pumping light.

12. The method according to claim 11, wherein the internal combustion engine is arranged as an internal combustion engine of a motor vehicle.

13. The method according to claim 11, wherein the pumping light source includes a laser diode, and the radiation intensity of the pumping light is set by setting a corresponding control current of the laser diode.

14. The method according to claim 13, wherein the wavelength of the pumping light is modified using active tempering of the laser diode.

15. The method according to claim 11, wherein a temperature of at least one of (a) the laser-active solid and (b) the laser device is derived from a temperature of the internal combustion engine.

16. The method according to claim 11, wherein at least one of (i) a temperature of at least one of (a) the laser-active solid and (b) the laser device and (ii) a temperature of the pumping light source is taken into account in the regulation.

17. The method according to claim 11, wherein the pumping duration is limited to a maximally admissible pumping duration.

18. The method according to claim 11, wherein the regulation takes place as a function of a rotational speed of the internal combustion engine.

19. The method according to claim 11, wherein an interrelationship between at least one of (a) the radiation intensity of the pumping light, (b) the pumping duration, (c) the pumping starting time, and (d) the wavelength of the pumping light and the point of ignition is obtained from at least one of (a) a characteristics curve and (b) a characteristics map.

20. A system, comprising:
a control unit for an ignition device for an internal combustion engine, the control unit adapted to perform a method a method for operating the ignition device for the internal combustion engine having a laser device that includes a laser-active solid having a passive O-switch, the method including:
generating a laser pulse for eradiating into a combustion chamber;
providing a pumping light, by a pumping light source, for the laser-active solid of the laser device;
regulating a point of ignition, at which the laser pulse is generated, to a specifiable setpoint value by setting at least one of (a) a radiation intensity of the pumping light, (b) a pumping duration of the pumping light, (c) a pumping starting time of the pumping light, and (d) a wavelength of the pumping light.

21. The system according to claim 20, wherein the internal combustion engine is arranged as an internal combustion engine of a motor vehicle.
